(19) United States
(12) Patent Application Publication
(10) Pub. No.: US 2008/0183937 A1
(43) Pub. Date: Jul. 31, 2008

(54) Method and Apparatus to Reduce EMI Emissions Over Wide Port SAS Buses

(76) Inventors: Brian James Cagno, Tucson, AZ (US); Gregg Steven Lucas, Tucson, AZ (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/669,283

(22) Filed: Jan. 31, 2007

(51) Int. Cl. G06F 1/00

(52) U.S. Cl. 710/307

(57) ABSTRACT

A mechanism is provided for selecting IDLE patterns based on data being transmitted on the different ports of a wide lane serial attached small computer system interface cable. The mechanism examines the frequency content of the data bearing lanes and selects a DWORD to transmit for an IDLE that has a different frequency content to reduce spikes in electromagnetic interference emissions at a given frequency.

### BACKGROUND

1. Technical Field

The present application relates generally to an improved data processing system and method. More specifically, the present application is directed to a method and apparatus to reduce electromagnetic interference emissions over wide port serial attached small computer system interface buses.

2. Description of Related Art

Small computer system interface (SCSI) is a hardware interface that allows for the connection of up to fifteen peripheral devices to a SCSI host adapter. SCSI uses a bus structure and functions like a mini-network connecting sixteen devices, with the host adapter counting as one device. SCSI allows any two devices to communicate at one time.

Serial attached SCSI (SAS) is merging as the next adopted high end hard disk drive (HDD). SAS is a serial version of the SCSI interface, which has been parallel since its inception in 1986. SAS is a point-to-point architecture that uses a host bus adapter with four or more channels that operate simultaneously.

With a recent and swift adoption of SAS as a preferred interface for storage systems, new technology hurdles are being placed before engineers. A wide port SAS bus consists of a plurality of different bidirectional lanes, such as four lanes, for example, of data that are logically linked together to increase throughput and enhance reliability. The most common use of the wide port connection is over the cable ports. The cables that support SAS today are copper only. High frequency signals may be as high as 3 GHz today and are moving toward 6 GHz in the near future. With the wide port cable, four lanes of bidirectional SAS data over a single copper cable, the electromagnetic interference (EMI) emissions density is very high given so many high frequency signals in such a small area.

Using differential signals intra-pair greatly reduces EMI for that pair, because two signals moving in opposite directions end up canceling out each other's magnetic fields. However, the inter-pair (pair-to-pair) magnetic fields now come into play for wide lane cables.

The current solution is to shield the cable using a metal layer on the outside area of the cable. However, this technique is not preventative in nature, but is merely reactive. For larger systems, sometimes it is required to design an “EMI door” and all the cables must be routed behind the door. In other words, current solutions react to EMI emissions in wide lane SAS cables by shielding the cables and/or placing the cables in a shielded box with a door for access.

The illustrative embodiments recognize the disadvantages of the prior art and provide a mechanism for selecting IDLE patterns based on data being transmitted on the different ports of a wide lane serial attached small computer system interface cable. The mechanism examines the frequency content of the data bearing lanes and selects a DWORD to transmit for an IDLE that has a different frequency content to reduce spikes in electromagnetic interference emissions at a given frequency.

In one illustrative embodiment, a computer program product comprises a computer useable medium having a computer readable program. The computer readable program, when executed on a computing device, causes the computing device to receiving data to be transmitted over a subset of a plurality of lanes of a wide port cable, determine a frequency level of the data to be transmitted over each of the subset of the plurality of lanes, and select an IDLE character for at least one of the plurality of lanes based on the frequency level of the data to be transmitted over each of the subset of the plurality of lanes.

In one exemplary embodiment, the wide port cable is a serial attached small computer system interface cable.

In another exemplary embodiment, the data is an 8-bit value. The computer readable program, when executed on the computing device, further causes the computing device to convert the 8-bit value to a 10-bit value using 8b10b encoding. In a further exemplary embodiment, the IDLE character is an 8-bit value. The computer readable program, when executed on the computing device, further causes the computing device to convert the IDLE character to a 10-bit value using 8b10b encoding.

In yet another exemplary embodiment, the computer readable program, when executed on the computing device, further causes the computing device to transmit the data and the at least one IDLE character across the plurality of lanes. In a further exemplary embodiment, the selected IDLE character has a different frequency level than the frequency level of the data to be transmitted over each of the subset of the plurality of lanes. In a still further exemplary embodiment, selecting an IDLE character for at least one of the plurality of lanes comprises selecting an IDLE character from a look-up table.

In another illustrative embodiment, an apparatus is provided in a serial attached small computer system interface device for reducing electromagnetic interference emissions in a wide port cable. The apparatus comprises a processor and a plurality of serial attached small computer system interface ports configured transmit data over a wide port serial attached small computer system interface cable having a plurality of lanes of data traffic corresponding to the plurality of serial attached small computer system interface ports. The processor is configured to receive data to be transmitted over a subset of the plurality of lanes, determine a frequency level of the data to be transmitted over each of the subset of the plurality of lanes, select an IDLE character for at least one of the plurality of lanes based on the frequency level of the data to be transmitted over each of the subset of the plurality of lanes, and transmit the data and the at least one IDLE character across the plurality of lanes.

In one exemplary embodiment, the wide port cable comprises four lanes of data traffic.

In another exemplary embodiment, the data is an 8-bit value, and the processor is further configured to convert the 8-bit value to a 10-bit value using 8b10b encoding. In a further exemplary embodiment, the IDLE character is an 8-bit value, and the processor is further configured to converting the IDLE character to a 10-bit value using 8b10b encoding.

In yet another exemplary embodiment, the selected IDLE character has a different frequency level than the frequency level of the data to be transmitted over each of the subset of the plurality of lanes. In a still further exemplary embodiment, the apparatus further comprises a look-up table, and the processor is configured to select an IDLE character for at least one of the plurality of lanes by selecting an IDLE character from a look-up table.

In a further illustrative embodiment, a method is provided for reducing electromagnetic interference emissions in a wide port cable. The wide port cable comprises a plurality of lanes of data traffic. The method comprises receiving data to be transmitted over a subset of the plurality of lanes, determining a frequency level of the data to be transmitted over each of the subset of the plurality of lanes, and selecting an IDLE character for at least one of the plurality of lanes based on the frequency level of the data to be transmitted over each of the subset of the plurality of lanes.

In one exemplary embodiment, the wide port cable is a serial attached small computer system interface cable.

In another exemplary embodiment, the data is an 8-bit value, and the method further comprises converting the 8-bit value to a 10-bit value using 8b10b encoding. In a further exemplary embodiment, the IDLE character is an 8-bit value, and the method further comprises converting the IDLE character to a 10-bit value using 8b10b encoding.

In yet another exemplary embodiment, the method further comprises transmitting the data and the at least one IDLE character across the plurality of lanes. In a still further exemplary embodiment, the selected IDLE character has a different frequency level than the frequency level of the data to be transmitted over each of the subset of the plurality of lanes. In another exemplary embodiment, selecting an IDLE character for at least one of the plurality of lanes comprises selecting an IDLE character from a look-up table.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an exemplary distributed data processing system in which aspects of the illustrative embodiments may be implemented;

FIG. 2 is a block diagram illustrating an example of a host connected to a storage enclosure over a wide port serial attached small computer system interface cable in accordance with an illustrative embodiment;

FIGS. 3A, 3B, 4A, 4B, 5A, and 5B illustrate examples of reducing electromagnetic interference spikes in a wide port serial attached SCSI cable in accordance with illustrative embodiments; and

FIG. 6 is a flowchart illustrating the operation of a mechanism for reducing electromagnetic interference spikes in a wide port serial attached SCSI cable in accordance with an illustrative embodiment.

### DETAILED DESCRIPTION OF THE ILLUSTRATIVE EMBODIMENTS

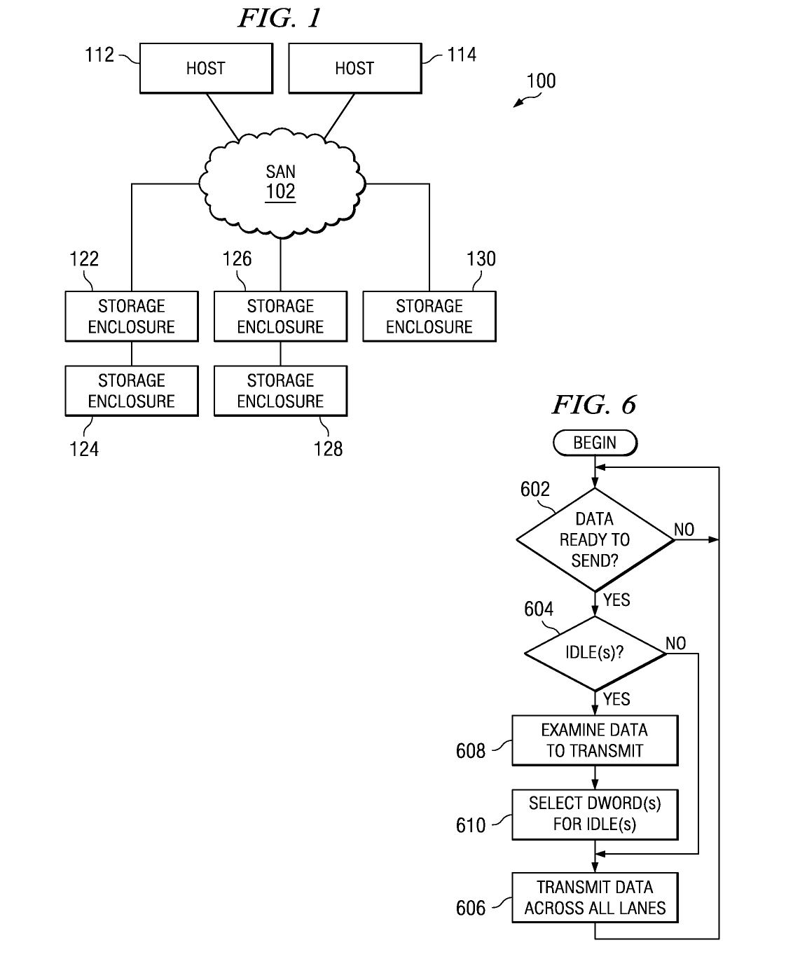

With reference now to the figures and in particular with reference to FIG. 1, an exemplary diagram of a data processing environment is provided in which illustrative embodiments of the present invention may be implemented. It should be appreciated that FIG. 1 is only exemplary and is not intended to assert or imply any limitation with regard to the environments in which aspects or embodiments of the present invention may be implemented. Many modifications to the depicted environment may be made without departing from the spirit and scope of the present invention.

FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one storage area network (SAN) 102, which is the medium used to provide communication links between various devices and computers connected together within distributed data processing system 100. The storage network 102 may include connections, such as wire, wireless communication links, or, in one embodiment, fiber optic cables.

In the depicted example, hosts 112 and 114 are connected to SAN 102. In addition, storage enclosures 122, 126, and 130 are also connected to network 102. Storage enclosure 124 is connected to storage enclosure 122, and storage enclosure 128 is connected to storage enclosure 126. Distributed data processing system 100 may include additional hosts, storage enclosures, and other devices not shown. Storage enclosures 122-130 may be, for example, serial attached SCSI (SAS) storage enclosures.

In one exemplary embodiment, host devices 112, 114 and storage enclosures 122-130 may be connected using wide port SAS cables. A wide port SAS bus consists of four different bidirectional lanes of data that are logically linked together to increase throughput and enhance reliability. The most common use of the wide port connection is over the cable ports. The cables that support SAS today are copper only. With the wide port cable, four lanes of bidirectional SAS data over a single copper cable, the electromagnetic interference (EMI) emissions density is very high given so many high frequency signals in such a small area.

Using differential signals intra-pair greatly reduces EMI for that pair, because two signals moving in opposite directions end up canceling out each other's magnetic fields. However, the inter-pair (pair-to-pair) magnetic fields now come into play for wide lane cables. Thus, in accordance with illustrative embodiments described herein, a mechanism is provided for selecting IDLE patterns based on data being transmitted on the different ports of the wide lane SAS cable. The mechanism examines the frequency content of the data bearing lanes and selects a DWORD to transmit for an IDLE that has a different frequency content to reduce spikes in electromagnetic interference emissions at a given frequency.

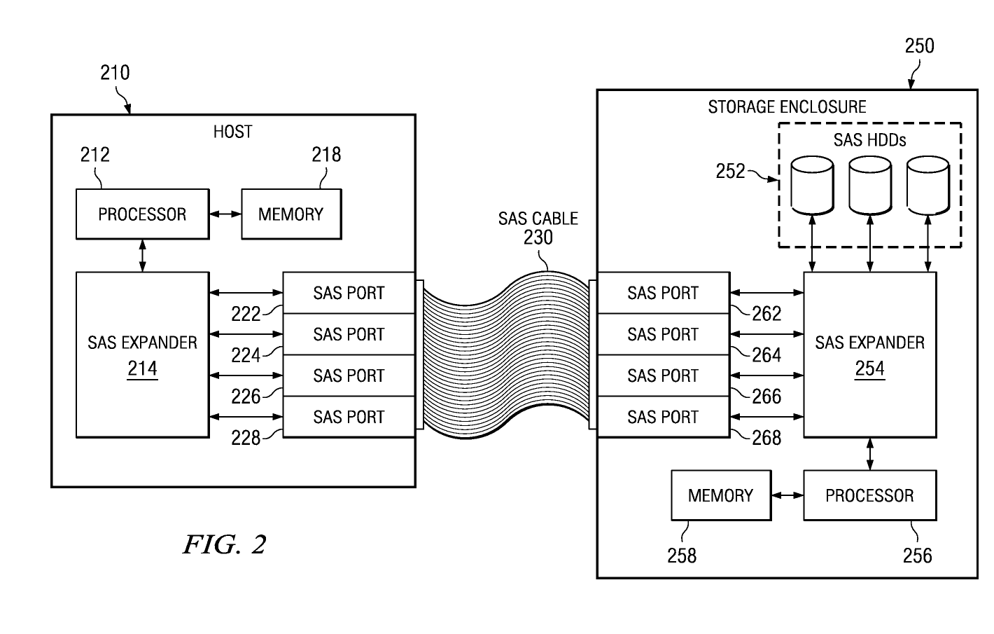

FIG. 2 is a block diagram illustrating an example of a host connected to a storage enclosure over a wide port serial attached small computer system interface cable in accordance with an illustrative embodiment. Host device 210 comprises a processor 212 connected to SAS expander 214 and memory 218. Host 210 is connected to storage enclosure 250 via serial attached SCSI cable 230. Host device 210 connects to SAS cable 230 using SAS ports 222-228.

Storage enclosure 250 comprises a plurality of serial attached SCSI (SAS) hard disk drives 252 connected to SAS expander 254. Processor 256 is connected to SAS expander 254 and memory 258. Storage enclosure 250 connects to SAS cable 230 using SAS ports 262-268.

While host 210 is connected to storage enclosure 250 via a single SAS cable in FIG. 2, host 210 may be attached to storage enclosure 250, and perhaps other storage enclosures, storage devices, or host devices, through a storage area network (SAN) comprising one or more switches and cables.

SAS, as with Fibre Channel, uses 8b10b encoding for transmitted data. In this encoding scheme, an 8-bit data word is converted to a 10-bit data word. The reason for this conversion is to ensure that no more than four logic level ones or four logic level zeros appear in a row. Along with the 8-bit to 10-bit conversion, there are also two copies of each 10-bit word. The two copies are used to keep neutral disparity, the same number of ones and zeros, across a link over multiple characters sent. For example, when sending the 8-bit data stream ‘00010001’b, the data is converted into one of two different 10-bit data streams ‘1000111011’b or ‘1000110100’b. The letter “b” indicates that the number is binary. The first 10-bit number has one more one (1) than zeros (0), and the second 10-bit number has one more zero (0) than ones (1). When sending back-to-back 8-bit data streams of ‘00010001’b, one would send the two different copies of the 10-bit versions giving the same number of ones and zeros over the 20 bits of data sent across the link.

In accordance with one illustrative embodiment, a mechanism in a device, such as a host device or storage enclosure, monitors the data transmitted via the SAS ports connected to the wide port SAS cable 230 to ensure the frequency content is spread across the EMI spectrum to help reduce average spikes. When the link is IDLE, a device generally sends a random, or at least arbitrary, DWORD (double word, or 8 bits of data). Given the flexibility of what may be sent as an IDLE, and given the numerous transmission options, two 10-bit values for every one 8-bit value, the mechanism may spread the frequency content among the lanes of SAS traffic, thus reducing cable EMI.

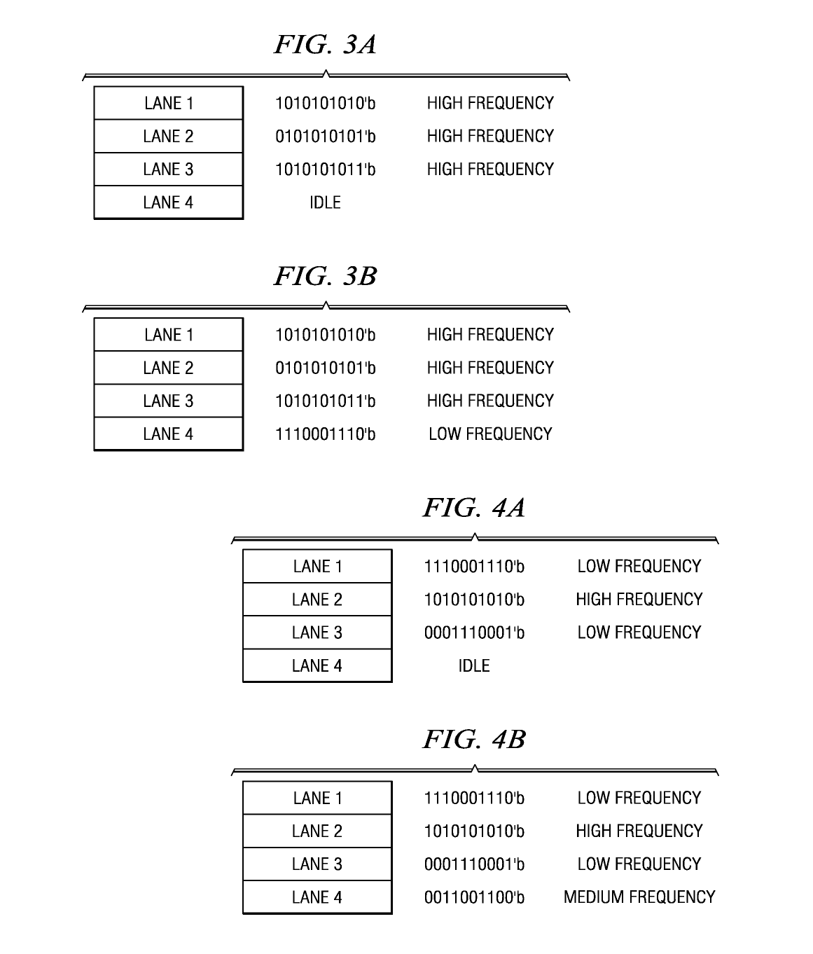

FIGS. 3A, 3B, 4A, 4B, 5A, and 5B illustrate examples of reducing electromagnetic interference spikes in a wide port serial attached SCSI cable in accordance with illustrative embodiments. More particularly, with reference to FIG. 3A, four lanes of serial attached SCSI (SAS) traffic are shown. Lane 1 transmits an 8-bit value that is converted to the 10-bit value ‘1010101010’b. Lane 2 transmits an 8-bit value that is converted to the 10-bit value ‘0101010101’b. Lane 3 transmits an 8-bit value that is converted to the 10-bit value ‘1010101011’b. Lane 4 is transmitting an IDLE character.

One can see that in the first three lanes of the wide port, there is a very high frequency component to the data being transmitted. Nearly all three lanes are alternating ones and zeros at the same time. This would produce a large emission at 1.5 GHz given a 3 GHz clock frequency, for example. Since the fourth lane is to send a random, or arbitrary, DWORD for an IDLE character, the mechanism may select a DWORD that has lower frequency content. If another high frequency DWORD is chosen, then the IDLE character would add to the same frequency as the data, which may cause a spike in EMI. However, if a DWORD with lower frequency content is chosen, then it will not add more power to the high frequency content.

In the example shown in FIG. 3B, the mechanism selects the hexadecimal character 0xE7, with a 10-bit encoding of ‘1110001110’b. The characters “0x” indicate that the number “E7” is hexadecimal. The frequency content of lane 4 in FIG. 3B is ⅛ the clock frequency, or 375 MHz. When one looks at the frequency spectrum of emitted power, the peak power at 1.5 GHz will be lower than if lane 4 had sent a different character that contained alternating ones and zeros.

The mechanism may select a DWORD for an IDLE using a look-up table, for example. Returning to FIG. 2, processor 212 in host device 210 or processor 256 in storage enclosure 250 may execute program instructions, such as firmware. For example, memory 218 or memory 258 may be read-only memory (ROM) devices that store firmware to be run on the processor. The program instructions may include conditional statements that select a DWORD for an IDLE from a pool of DWORDS known to have particular frequency content. In other words, the program code instructs the processor to determine desired frequency content for the IDLE character and to select a DWORD having that frequency content. The processor may then find a DWORD in a look-up table, which may store one or more DWORDs for each frequency level. The look-up table may be stored in memory 218 or memory 258, for example.

In the example depicted in FIGS. 3A and 3B, two frequency levels are shown. However, a person of ordinary skill in the art will recognize that more than two frequency levels may be used. Turning to FIG. 4A, four lanes of serial attached SCSI (SAS) traffic are shown. Lane 1 transmits an 8-bit value that is converted to the 10-bit value ‘1110001110’b. Lane 2 transmits an 8-bit value that is converted to the 10-bit value ‘1010101010’b. Lane 3 transmits an 8-bit value that is converted to the 10-bit value ‘0001110001’b. Lane 4 is transmitting an IDLE character.

One can see that in the first and third lanes of the wide port, there is a low frequency component to the data being transmitted. These two lanes are transmitting ones and zeros at a rate of ⅛ the clock frequency. If the IDLE character has frequency content at the same frequency level, then this could produce a large emission at 375 MHz given a 3 GHz clock frequency, for example. Since the fourth lane is to send a random, or arbitrary, DWORD for an IDLE character, the mechanism may select a DWORD that has medium frequency content so that it will not add more power to the low frequency content of the first and third lanes or the high frequency content of the second lane.

In the example shown in FIG. 4B, the mechanism selects the DWORD with a 10-bit encoding of ‘0011001100’b. The frequency content of lane 4 in FIG. 4B is ¼ the clock frequency, or 750 MHz. When one looks at the frequency spectrum of emitted power, the peak power at 375 MHz will be lower than if lane 4 had sent an IDLE character that contained low frequency content.

Occasionally, more than one lane will send an IDLE character. With reference now to FIG. 5A, four lanes of serial attached SCSI (SAS) traffic are shown. Lane 1 transmits an 8-bit value that is converted to the 10-bit value ‘1010101010’b, which has high frequency content. Lane 2 transmits an 8-bit value that is converted to the 10-bit value ‘0101010101’b, which has high frequency content. Lane 3 and lane 4 are transmitting an IDLE character.

Thus, the first and second lanes of the wide port have a high frequency component to the data being transmitted. Therefore, if the IDLE characters have frequency content at the same frequency level, then this could produce a large emission spike. Since the third and fourth lanes are to send a random, or arbitrary, DWORD for an IDLE character, the mechanism may select DWORDs that have low and/or medium frequency content so that they will not add more power to the high frequency content of the first and second lanes. As seen in the example shown in FIG. 5B, the mechanism may select a medium frequency DWORD for the IDLE character of lane 3 and a low frequency DWORD for the IDLE character of lane 4.

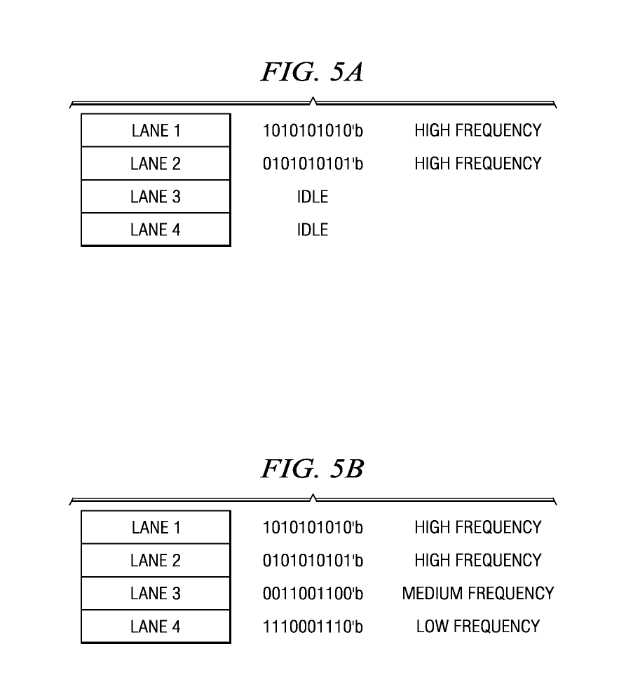

FIG. 6 is a flowchart illustrating the operation of a mechanism for reducing electromagnetic interference spikes in a wide port serial attached SCSI cable in accordance with an illustrative embodiment. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware, such as a state machine, and computer instructions.

Furthermore, the flowchart is provided to demonstrate the operations performed within the illustrative embodiments. The flowchart is not meant to state or imply limitations with regard to the specific operations or, more particularly, the order of the operations. The operations of the flowchart may be modified to suit a particular implementation without departing from the spirit and scope of the present invention.

With reference now to FIG. 6, operation begins and the mechanism determines whether the device is ready to send data (block 602). If the device is not ready to send data, operation returns to block 602 until the device is ready to send data. The device may be a host device or storage enclosure, for example, that is configured to communicate SAS traffic over a wide port SAS cable.

If the device is ready to send data in block 602, the mechanism determines whether one or more IDLE characters are to be sent over the lanes of the wide port cable (block 604). If no IDLE characters are to be sent, the mechanism transmits the data across all lanes (block 606), and operation returns to block 602 to determine whether the device is ready to send data. In this case, the data may or may not result in all lanes having the same frequency content. However, over the course of time, and due to the SAS protocol, a device cannot keep every lane busy all of the time. There will usually be an IDLE on at least one lane, depending on the amount of traffic.

If at least one IDLE is to be transmitted in block 604, the mechanism examines the data to be transmitted to determine the frequency content of the data (block 608). Then, the mechanism selects a DWORD for each IDLE character based on the frequency content of the data (block 610). Thereafter, the mechanism transmits the data, including the IDLE character(s), across all lanes (block 606), and operation returns to block 602 to determine whether the device is ready to send data.

Thus, the illustrative embodiments solve the disadvantages of the prior art by providing a mechanism for selecting IDLE patterns based on data being transmitted on the different ports of a wide lane serial attached small computer system interface cable. The mechanism examines the frequency content of the data bearing lanes and selects a DWORD to transmit for an IDLE that has a different frequency content to reduce spikes in electromagnetic interference emissions at a given frequency.

It should be appreciated that the illustrative embodiments may take the form of an entirely hardware embodiment, an entirely software embodiment or an embodiment containing both hardware and software elements. In one exemplary embodiment, the mechanisms of the illustrative embodiments are implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer program product comprising a computer useable medium having a computer readable program, wherein the computer readable program, when executed on a computing device, causes the computing device to:
receiving data to be transmitted over a subset of a plurality of lanes of a wide port cable;
determine a frequency level of the data to be transmitted over each of the subset of the plurality of lanes; and
select an IDLE character for at least one of the plurality of lanes based on the frequency level of the data to be transmitted over each of the subset of the plurality of lanes.

2. The computer program product of claim 1, wherein the wide port cable is a serial attached small computer system interface cable.

3. The computer program product of claim 1, wherein the data is an 8-bit value, wherein the computer readable program, when executed on the computing device, further causes the computing device to:
convert the 8-bit value to a 10-bit value using 8b10b encoding.

4. The computer program product of claim 3, wherein the IDLE character is an 8-bit value, wherein the computer readable program, when executed on the computing device, further causes the computing device to:
convert the IDLE character to a 10-bit value using 8b10b encoding.

5. The computer program product of claim 1, wherein the computer readable program, when executed on the computing device, further causes the computing device to:
transmit the data and the at least one IDLE character across the plurality of lanes.

6. The computer program product of claim 1, wherein the selected IDLE character has a different frequency level than the frequency level of the data to be transmitted over each of the subset of the plurality of lanes.

7. The computer program product of claim 1, wherein selecting an IDLE character for at least one of the plurality of lanes comprises selecting an IDLE character from a look-up table.

8. An apparatus in a serial attached small computer system interface device for reducing electromagnetic interference emissions in a wide port cable, the apparatus comprising:
a processor; and
a plurality of serial attached small computer system interface ports configured transmit data over a wide port serial attached small computer system interface cable having a plurality of lanes of data traffic corresponding to the plurality of serial attached small computer system interface ports,
wherein the processor is configured to receive data to be transmitted over a subset of the plurality of lanes, determine a frequency level of the data to be transmitted over each of the subset of the plurality of lanes, select an IDLE character for at least one of the plurality of lanes based on the frequency level of the data to be transmitted over each of the subset of the plurality of lanes, and transmit the data and the at least one IDLE character across the plurality of lanes.

9. The apparatus of claim 8, wherein the wide port cable comprises four lanes of data traffic.

10. The apparatus of claim 8, wherein the data is an 8-bit value, and wherein the processor is further configured to convert the 8-bit value to a 10-bit value using 8b10b encoding.

11. The apparatus of claim 10, wherein the IDLE character is an 8-bit value, and wherein the processor is further configured to converting the IDLE character to a 10-bit value using 8b10b encoding.

12. The apparatus of claim 8, wherein the selected IDLE character has a different frequency level than the frequency level of the data to be transmitted over each of the subset of the plurality of lanes.

13. The apparatus of claim 8, further comprising:
a look-up table,
wherein the processor is configured to select an IDLE character for at least one of the plurality of lanes by selecting an IDLE character from a look-up table.

14. A method for reducing electromagnetic interference emissions in a wide port cable, wherein the wide port cable comprises a plurality of lanes of data traffic, the method comprising:
receiving data to be transmitted over a subset of the plurality of lanes;
determining a frequency level of the data to be transmitted over each of the subset of the plurality of lanes; and
selecting an IDLE character for at least one of the plurality of lanes based on the frequency level of the data to be transmitted over each of the subset of the plurality of lanes.

15. The method of claim 14, wherein the wide port cable is a serial attached small computer system interface cable.

16. The method of claim 14, wherein the data is an 8-bit value, the method further comprising:
converting the 8-bit value to a 10-bit value using 8b10b encoding.

17. The method of claim 16, wherein the IDLE character is an 8-bit value, the method further comprising:
converting the IDLE character to a 10-bit value using 8b10b encoding.

18. The method of claim 14, further comprising:
transmitting the data and the at least one IDLE character across the plurality of lanes.

19. The method of claim 14, wherein the selected IDLE character has a different frequency level than the frequency level of the data to be transmitted over each of the subset of the plurality of lanes.

20. The method of claim 14, wherein selecting an IDLE character for at least one of the plurality of lanes comprises selecting an IDLE character from a look-up table.
